(19) United States
(12) Patent Application Publication
(10) Pub. No.: US 2023/0036452 A1
(43) Pub. Date: Feb. 2, 2023

(54) DUAL THREE-POINT RESTRAINT SYSTEM

(71) Applicant: Safe, Inc., Tempe, AZ (US)

(72) Inventors: Marvin RICHARDS, Mesa, AZ (US); Stanley DESJARDINS, Scottsdale, AZ (US)

(21) Appl. No.: 17/846,546

(22) Filed: Jun. 22, 2022

Related U.S. Application Data
(60) Provisional application No. 63/226,353, filed on Jul. 28, 2021.

(51) Int. Cl. B60R 22/02; B60R 22/24; B60R 22/32; B60R 22/34

(52) U.S. Cl. CPC B60R 22/023; B60R 22/24; B60R 22/32; B60R 22/34; B60R 2022/1806

(57) ABSTRACT

A restraint system is disclosed for use in vehicle seats that provides enhanced occupant restraint while minimizing belt loading injuries, is intuitive to don and remove, and includes an emergency release feature to allow rapid seat egress by eliminating continuous belt loops. The restraint uses improved belt routing to minimize upper torso rotation, which is critical for vehicles where occupant flail injuries from contact with the vehicle interior are likely. The installed restraint includes a crisscross belt pattern across both the occupant's upper torso and pelvis region, with an alternate configuration which incorporates a single lap belt. The restraint has demonstrated significantly reduced upper torso rotation compared to the current state-of-the-art, 5-point restraint system when exposed to a typical aerospace combined vertical and longitudinal crash pulse yet is as intuitive to don as the typical automotive-style 3-point restraint system.

### BACKGROUND OF THE INVENTION

This invention relates generally to seat belt system, and in particular to multiple point seat belt systems.

Seat belt restraint systems are used to restrict occupant motion during high acceleration events occurring in crashes of both ground and aerospace vehicles. The primary goal is to reduce injury potential caused by occupant flail impact with the vehicle interior, while minimizing injury directly from the restraint belt loading.

A common belt restraint is the 3-point restraint system as disclosed in U.S. Pat. No. 3,847,434 to Wemen, which is now used on most commercial automotive platforms. The 3-point restraint includes a lap belt to limit pelvis excursion together with a diagonal torso belt to limit upper torso excursion (torso forward rotation). The load path of the torso belt anchorage points is typically located near or aft of the occupant's back tangent line, which provides a near ideal loading vector to limit upper torso forward rotation. Typically, 3-point restraint systems combine the lap belt and torso belt as a continuous loop with a static anchor near the occupant's hip and a retracting inertia reel anchor near shoulder level on the same side. The belt loop passes through a sliding latch plate that is latched to a single buckle near the occupant's hip on the opposite side. This design simplifies restraint donning, adjustment, and removal. There are three drawbacks to 3 point restraint systems. First, accelerations with a lateral component opposite the upper torso belt mounting point can cause the torso to rotate out of the restraint allowing impact with secondary vehicle structure. Second, tension in the single torso belt can be very high, which can contribute to occupant chest injury (i.e., rib fracture). Third, a continuous webbing loop can cause potential occupant entrapment. This is a concern for vehicles where rapid egress is desired, such as exiting an aircraft after a water ditching or a crash that includes a post-crash fire.

A 4-point restraint adds a second torso belt (one over each shoulder) to prevent upper torso rotation out of the restraint during events with a lateral component in either direction. The second belt also limits localized occupant chest loading as forward inertial loading is reacted by two belts rather than one. The lower anchors of the torso belts are typically mounted to a release buckle near the center of the lap belt. Activation of the buckle releases both torso belts and the lap belt, which eliminates the potential entrapment hazard. However, anchoring the torso belts to the center of the lap belt causes two undesirable consequences. Firstly, the torso belts can lift the center of the lap belt upward, which can allow the occupant's pelvis to rotate under the lap belt during crash loading. This event is referred to as pelvic “submarining,” which can cause serious injury. Secondly, the lower torso belt loading vector is now in front of the occupant's torso so the seat belt net aftward force is reduced, allowing increased upper torso forward rotation. These two undesirable characteristics are exacerbated during aerospace crash events, which often include a combined downward and forward acceleration.

To limit pelvic submarining potential, a tie-down belt can be added from the release buckle to the seat pan passing between the occupant's legs (also called a crotch strap). A restraint with this added belt is commonly referred to as a 5-point restraint. While 5-point restraints minimize the submarining potential, the upper torso belts loading vector still allows extensive torso rotation during a combined forward and vertical acceleration event (crash).

In addition to the suboptimal belt geometry issues, some seat occupants (such as troops sitting in cabin seats) are not familiar with the current 4-point and 5-point restraint systems. Additionally, the shoulder belt mounting (shoulder height near the seat centerline) makes the belts difficult to access, and correctly donning the system requires finding, plugging in and tightening four separate belts. UH-60 crash data (the only U.S. Army helicopter with cabin seat shoulder belts available since inception) showed that only 42 percent of cabin occupants in crashes were wearing the available shoulder belts. In the commercial sector, occupants wearing skirts or similar clothing typically will not don a 5-point restraint as the path for the crotch strap is blocked. In addition, some occupants are fearful of the crotch strap causing groin injuries, even though testing and crash data show this injury mechanism to be unlikely. Ultimately, 5-point restraint systems are typically shunned in the commercial market and typically only used on military platforms or by the automotive racing industry.

### SUMMARY OF THE INVENTION

The present invention comprises a restraint system with improved belt routing geometry to reduce the occupant's motion and associated injury risk that is intuitive to don with minimal installation instruction. This is critical for platforms where the interior cannot be adequately delethalized and in which the use of supplemental restraints, such as airbags, is impractical.

According to an illustrative embodiment of the invention, the restraint system is donned in a manner similar to standard 3-point restraints used in most automobiles. A side mounted belt with a webbing retractor reel (or inertia reel) on the top mount feeds through a sliding latch plate with a lower terminal belt mount near the intersection of the seat pan and back surface (commonly called the SRP, or Seat Reference Point). The lower terminal belt mount differs from the prior art restraint as it is a releasable fitting, as opposed to a static dead end. After sitting in the seat, the first step to don the restraint is to pull the sliding latch plate across the upper torso and plug it into the release buckle on the opposite side. This action results in a diagonal belt across the torso and a lap belt over the pelvis similar to the standard 3-point restraint system. A second mirror image of the belt is provided on the other side of the seat which is then installed resulting in a crisscross belt pattern over both the torso and the pelvis.

Two methods are provided for removing the restraint in the illustrative embodiment. The first method is to depress a button on each of the plug-in buckles on the sides of the seat, similar to the familiar automotive system, but repeated for each side. The second method is to activate an emergency release handle, which releases both plug-in buckles and both terminal end fittings of the belts. This eliminates the potential belt closed-loop entrapment hazard allowing rapid egress. The entrapment hazard is a particular concern of the aerospace industry due to post-crash fires or drowning hazard after water ditching. After emergency release, the terminal latch ends of the restraint belts would be latched back in place so that the next seat occupant could don the restraint in the familiar automotive fashion, as outlined above.

The illustrative restraint system provides improved restraint through its more direct load paths in the direction of desired restraint, thus reducing the occupant's strike envelope. The benefits of the improved restraint geometry have been successfully demonstrated through dynamic testing. Tests replicating the combined vertical and downward crash pulse of military rotorcraft crash events reduced upper torso motion by 39 percent compared to the current state-of-the-art, 5-point restraint system. In addition, total belt tension was reduced by 28 percent and chest compression reduced by 28 percent.

### BRIEF DESCRIPTION OF THE DRAWING

The present invention will be better understood from a reading of the following detailed description, taken in conjunction with the accompanying drawing figures in which like references designate like elements and, in which:

FIG. 1 is an isometric view of a vehicle seat having a restraint system incorporating features of the present invention;

FIG. 2 is an isometric view of the restraint system of FIG. 1 with the terminal ends of the seat belts attached to the lower anchor points;

FIG. 3 is an isometric view of the restraint system of FIG. 1 with the seat belts partially donned;

FIG. 4 is an isometric view of the restraint system of FIG. 1 with the seat belts fully donned;

FIG. 5 is a detail isometric view of the restraint system of FIG. 1 showing the right-side terminal buckle and the right side intermediate buckle;

FIG. 6 is a detail isometric view of an alternative embodiment reversing the positions of the right-side terminal buckle and the right side intermediate buckle;

FIG. 7 is an isometric view of an alternative embodiment of a restraint system incorporating features of the present invention;

FIG. 8 is an isometric view of an alternative embodiment of FIG. 7 with the terminal end of one belt attached to its lower anchor point; and

FIG. 9 is an isometric view of the alternative embodiment of FIG. 7 with the restraint system fully donned.

### DETAILED DESCRIPTION

The drawing figures are intended to illustrate the general manner of construction and are not necessarily to scale. In the detailed description and in the drawing figures, specific illustrative examples are shown and herein described in detail. It should be understood, however, that the drawing figures and detailed description are not intended to limit the invention to the particular form disclosed, but are merely illustrative and intended to teach one of ordinary skill how to make and/or use the invention claimed herein and for setting forth the best mode for carrying out the invention.

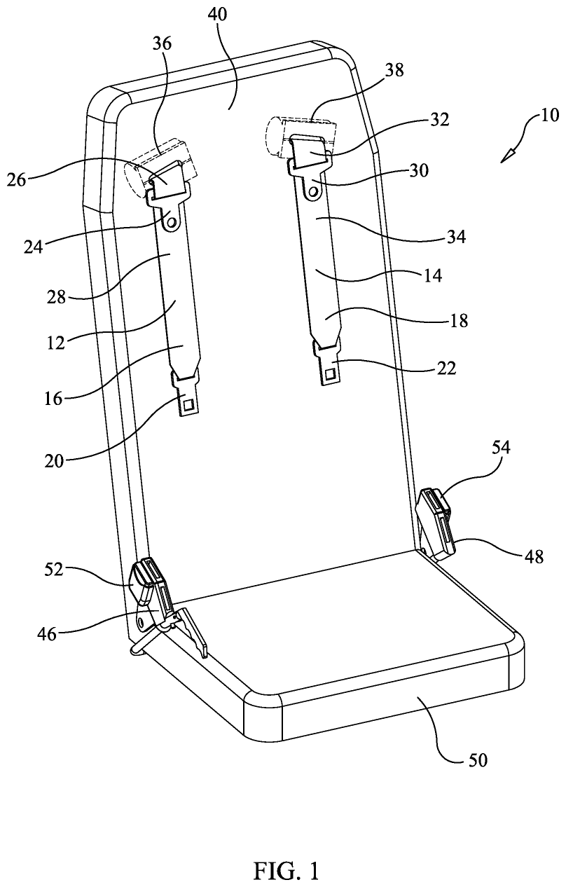

With reference to the figures and in particular FIG. 1, a restraint system 10 incorporating features of the present invention comprises a first seat belt 12 and a second seat belt 14 comprising a length of seat belt webbing or other suitable material. In the illustrative embodiment the free ends 16, 18 of seat belts 12, 14 each terminates in a terminal latch plate 20, 22. A sliding intermediate latch plate 24 threaded through the seat belt webbing of first seat belt 12 divides first seat belt 12 into an upper, shoulder portion 26 and a lower, lap portion 28. A sliding intermediate latch plate 30 threaded through the seat belt webbing of second seat belt 14 divides second seat belt 14 into an upper, shoulder portion 32 and a lower, lap portion 34. The shoulder portions 26, 32 of seat belts 12, 14 are secured to the vehicle frame by means of upper anchors, which in the illustrative embodiment comprise webbing retractors 36, 38 which are attached to the vehicle frame proximal the shoulder region of the seat back 40. As used herein, the vehicle “frame” means and refers to any structural part of the vehicle including the walls, floor, seat pan, seat back or any other part of the vehicle having suitable structural integrity to withstand the loads necessary to support the restraint system.

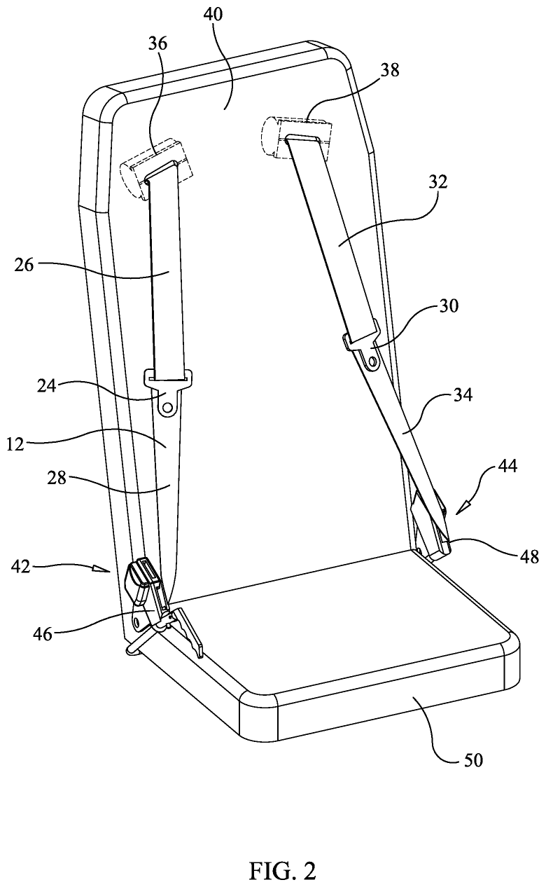

With additional reference to FIG. 2, prior to using restraint system 10 to secure an occupant, the lap portions 28, 34 of seat belts 12, 14 are secured to the vehicle frame by means of lower anchors 42, 44 which in the illustrative embodiment comprise terminal latch plates 20, 22 in combination with terminal buckles 46, 48, which themselves are attached to the vehicle frame on opposite sides of the seat pan 50 at or near the Seat Reference Point. Terminal latch plate 20 latches into terminal buckle 46 to form lower anchor 42 while terminal latch plate 22 latches into terminal buckle 48 to form lower anchor 44.

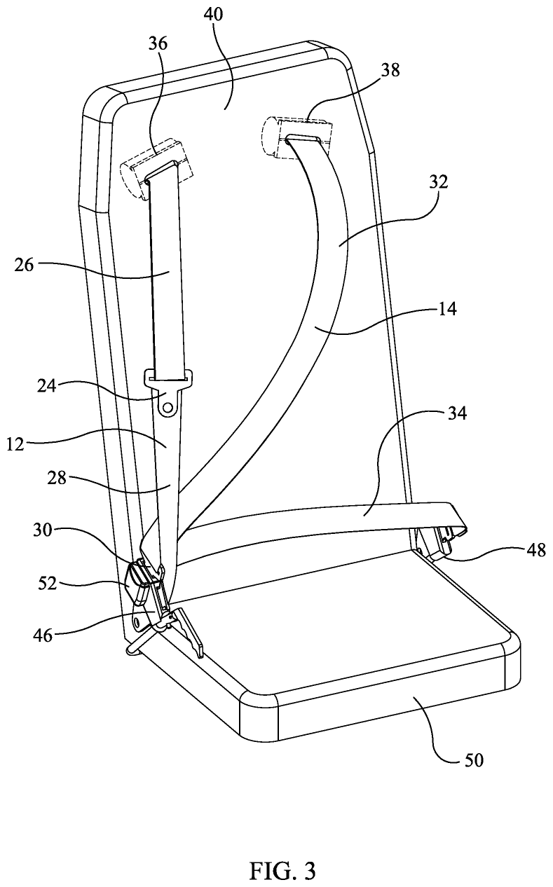

With additional reference to FIG. 3, restraint system 10 may be donned in a variety of ways, however, in the illustrative embodiment, the occupant (or an assistant) pulls the sliding intermediate latch plate 30 across the upper torso of the occupant and connects it to the receiving portion of intermediate buckle 52, which in the illustrative embodiment comprises a conventional push-button or lift-latch-buckle seat belt receiver. The action of connecting latch plate 30 to intermediate buckle 52 creates an intermediate latch that forms seat belt 14 into a familiar three-point restraint.

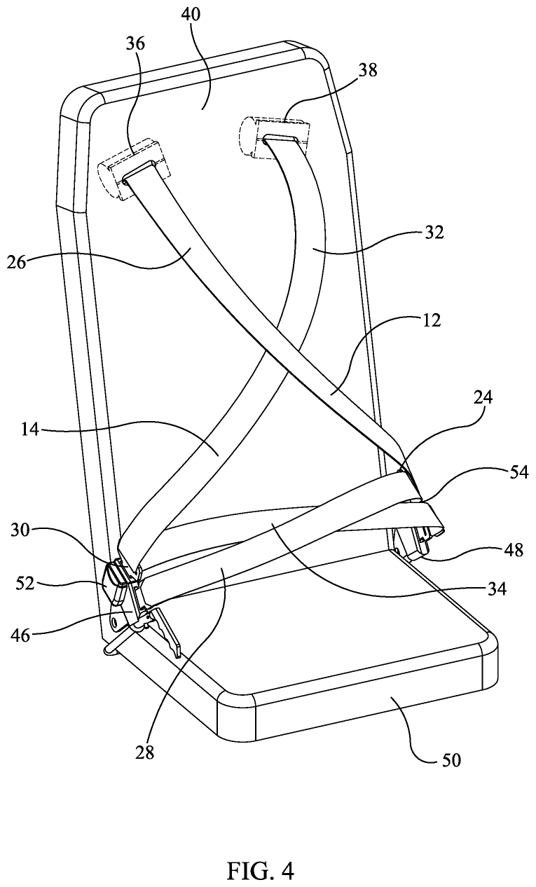

With additional reference to FIG. 4, donning of restraint system 10 continues by pulling the sliding intermediate latch plate 24 across the upper torso of the occupant and connecting it to the receiving portion of intermediate buckle 54, which in the illustrative embodiment comprises a conventional push-button or lift-latch-buckle seat belt receiver similar to buckle 52. The action of connecting latch plate 24 to intermediate buckle 54 creates an intermediate latch that forms seat belt 12 into a familiar three-point restraint which is essentially the mirror image of seat belt 14. It should be observed that, in the illustrative embodiment, measures are taken to prevent terminal latch plates 20, 22 from connecting to intermediate buckles 52, 54 and to prevent intermediate latch plates 24, 30 from connecting to terminal buckles 46, 48. For example, as shown in FIG. 1, the blades of terminal latch plates may be wider and/or incorporate a latching aperture that is a different size or shape than those of the intermediate latch plates.

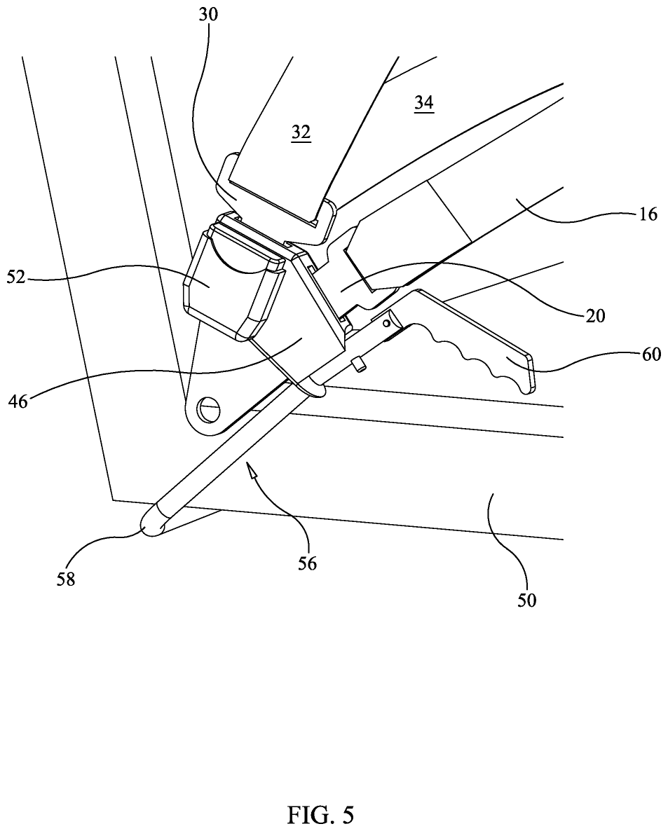

With additional reference to FIG. 5, restraint system 10 further includes a quick-release mechanism 56 which is interconnected with terminal buckles 46, 48 and intermediate buckles 52, 54 through a control link 58 so that pulling on release handle 60 releases terminal buckles 46, 48 and intermediate buckles 52, 54 substantially at the same time. As used herein a “quick release” means and refers to a push-button latch, twist latch, pin-and-clevis joint, solenoid actuated draw bar or other connection that can be detached in a non-destructive manner in less than 10 seconds, preferably less than 5 seconds and most preferably in less than 1 second as opposed to a threaded, staked, welded, stitched, explosive bolt or other connection that is either destructive or would take considerably longer than 10 seconds to detach.

In the illustrative embodiment, control link 58 comprises a Bowden-type cable operating on the release mechanisms of terminal buckles 46, 48 and intermediate buckles 52, 54 by withdrawing a sliding plate in a conventional manner. The release handle 60 is mounted on the right side of the seat pan 50. It is contemplated, however, that release handles could be mounted on either side of the seat pan or under the middle of the seat pan 50 and the control link 58 could comprise any conventional system for simultaneously releasing four mechanical latches including mechanical, electromechanical, magnetic, linear, rotary and the like without departing from the scope of the invention.

Under normal circumstances, restraint system 10 is doffed by releasing intermediate buckles 52, 54 in a conventional manner, e,g, by pressing the release buttons or lifting the latch buckles of intermediate buckles 52, 54 thereby releasing intermediate latch plates 24, 30 only. This will allow seat belts 12, 14 to resume the positions shown in FIG. 2. In this state, the two seat belt loops will need to be pulled off the occupant's shoulders prior to egress in the same manner as the familiar automotive 3-point restraint system (except with two loops rather than one). This engenders some potential for temporary closed-loop entrapment of the occupant, which is inconvenient, but not dangerous unless rapid egress is required, for example if there is a drowning or fire hazard. Where rapid egress is required, the quick-release mechanism is actuated. Pulling the release handle 60 simultaneously releases terminal buckles 46, 48 and intermediate buckles 52, 54 substantially at the same time. This will allow seat belts 12, 14 to resume the positions shown in FIG. 1, which eliminates the possibility of a closed-loop entrapment, further adding to the safety of restraint system 10.

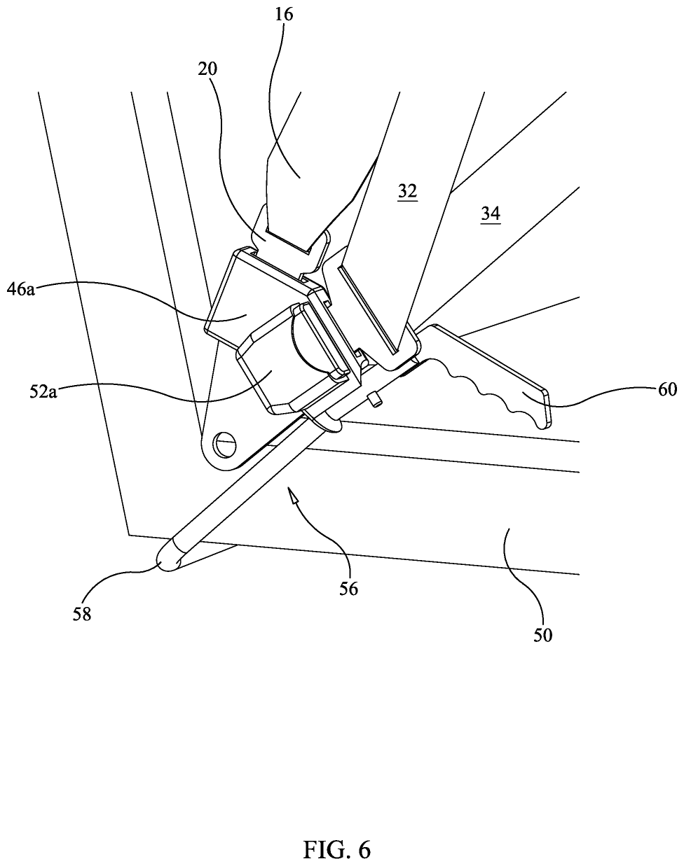

With additional reference to FIG. 6, in an alternative embodiment incorporating features of the present invention, terminal buckle 46A is mounted above and/or rearward of intermediate buckle 52A. Similarly, terminal buckle 48A is mounted above and/or rearward of intermediate buckle 54A (not shown). This positioning has the advantage of reducing the possibility that seat belts 12, 14 can become tangled when donning the restraint system 10, at the cost of reducing somewhat the optimal upper torso restraint.

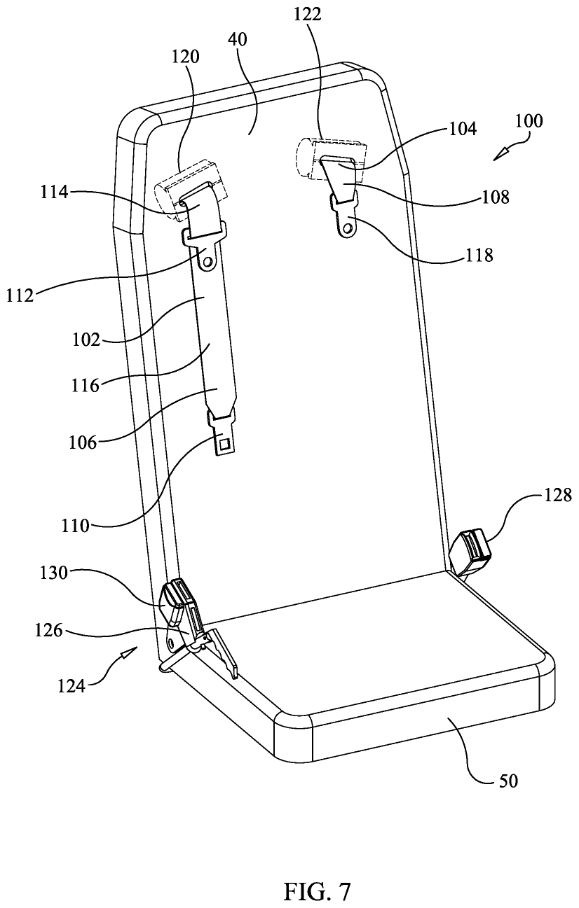

With additional reference to FIG. 7, in another alternative embodiment, restraint system 100 incorporating features of the present invention comprises a first seat belt 102 and a second seat belt 104 each comprising a length of seat belt webbing or other suitable material. In the illustrative embodiment the free end 106 of seat belt 102 terminates in a terminal latch plate 110. A sliding intermediate latch plate 112 threaded through the seat belt webbing of first seat belt 102 divides first seat belt 102 into an upper, shoulder portion 114 and a lower, lap portion 116. Free end 108 of second seat belt 104 terminates in a terminal latch plate 118, which, for reasons discussed more fully hereinafter is sized to be accepted by the receiving portion of a buckle having a push-button or lift-latch-buckle seat belt receiver, rather than a terminal buckle which can only be opened using the release handle as in the embodiment of FIG. 1. Seat belts 102, 104 are secured to the vehicle frame by means of upper anchors, which in the illustrative embodiment comprise webbing retractors 120, 122 which are attached to the vehicle frame proximal the shoulder region of the seat back 40.

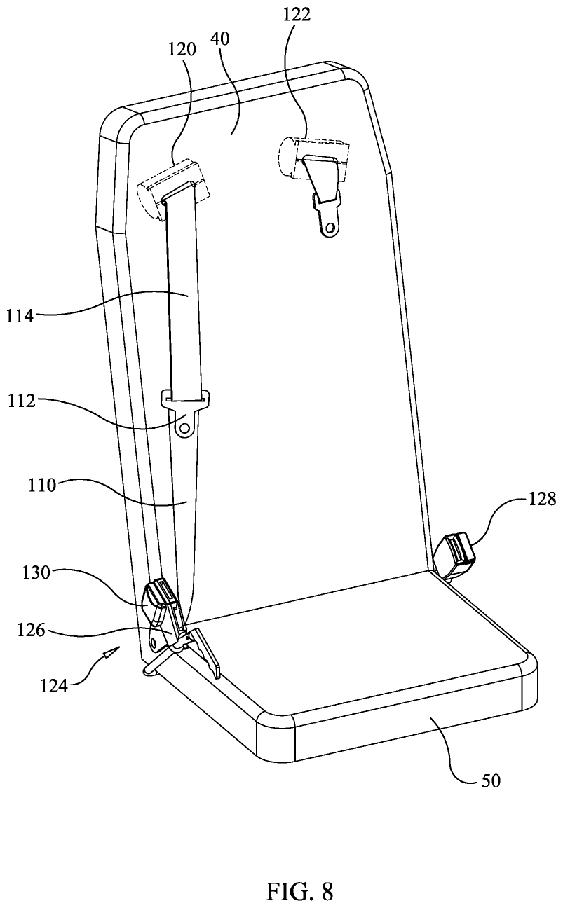

With additional reference to FIG. 8, prior to using restraint system 100 to secure an occupant, the lap portion 116 of seat belt 102 is secured to the vehicle frame by means of lower anchor 124, which in the illustrative embodiment comprises terminal latch plate 112 in combination with terminal buckle 126, which is attached to the vehicle frame at or near the Seat Reference Point.

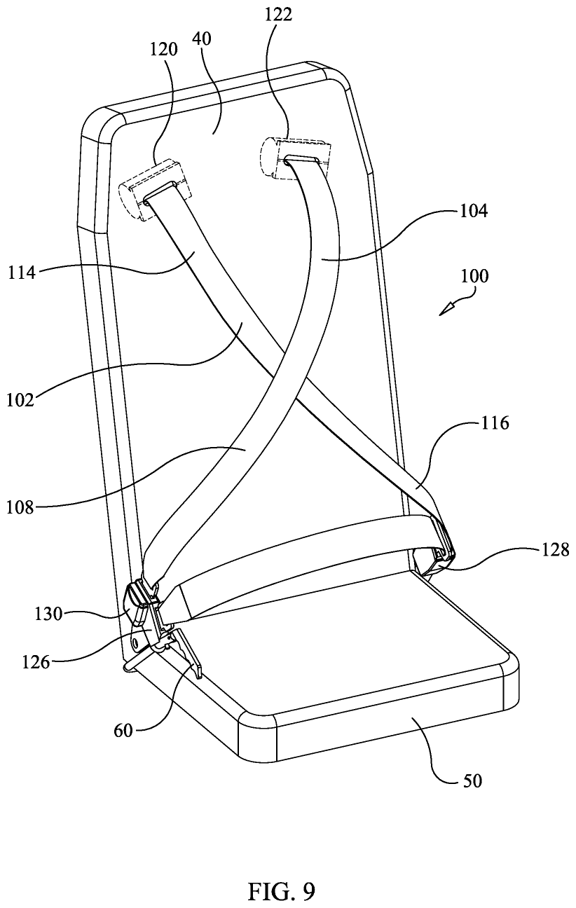

With additional reference to FIG. 9, restraint system 100 may be donned in a variety of ways, however, in the illustrative embodiment, the occupant (or an assistant) pulls the sliding intermediate latch plate 112 across the upper torso of the occupant and connects it to the receiving portion of intermediate buckle 128, which in the illustrative embodiment comprises a conventional push-button or lift-latch-buckle seat belt receiver. The action of connecting latch plate 112 to intermediate buckle 128 creates an intermediate latch that forms seat belt 102 into a familiar three-point restraint. Donning of restraint system 100 continues by pulling terminal latch plate 118 across the upper torso of the occupant and connecting it to the receiving portion of terminal buckle 130, which in this case is also a conventional push-button or lift-latch-buckle seat belt receiver. This action forms seat belt 104 into a diagonal 2-point restraint, however, the combination of seat belt 102 and seat belt 104 is the functional equivalent of a dual 3-point restraint.

As with the illustrative embodiment of FIG. 1, restraint system 100 further includes a quick-release mechanism 136 which is interconnected with terminal buckles 126, 130 and intermediate buckle 128 through a control link 140 so that pulling on release handle 140 releases terminal buckles 126, 130 and intermediate buckle 128 substantially at the same time.

Under normal circumstances, restraint system 100 is doffed by releasing intermediate buckle 128 and terminal buckle 130 in a conventional manner, e,g, by pressing the release buttons or lifting the latch buckles of intermediate buckle 128 and terminal buckle 130 thereby releasing intermediate latch 112 and terminal lath plate 118. This will allow seat belts 102, 104 to resume the positions shown in FIG. 8. In this state, one seat belt loop will need to be pulled off the occupant's shoulders prior to egress in the same manner as the familiar automotive 3-point restraint system. Where rapid egress is required, the quick-release mechanism is actuated. Pulling the release handle 60 releases 126, 130 and intermediate buckle 128 at substantially the same time. This will allow seat belts 102, 104 to resume the positions shown in FIG. 7, which eliminates the possibility of a closed-loop entrapment, further adding to the safety of restraint system 100.

Although certain illustrative embodiments and methods have been disclosed herein, it will be apparent from the foregoing disclosure to those skilled in the art that variations and modifications of such embodiments and methods may be made without departing from the invention. For example, although in the illustrative embodiment, webbing retractors are used to adjust the length of the seat belt webbing, a fixed mounting may also be used (together with appropriate belt length adjusters) without departing from the scope of the invention. Additionally, it would be possible to reverse the latch/tongue combinations so that the buckles are mounted on the webbing and the tongues are the anchors and/or mounting retractors on the floor so they act as anchors for the lap portion of the belt without departing from the scope of the invention. Accordingly, it is intended that the invention should be limited only to the extent required by the appended claims and the rules and principles of applicable law. Additionally, as used herein, references to direction such as “up” or “down” as well as recited materials or methods of attachment are intended to be exemplary and are not considered as limiting the invention and, unless otherwise specifically defined, the terms “generally,” “substantially,” or “approximately” when used with mathematical concepts or measurements mean within ±10 degrees of angle or within 10 percent of the measurement, whichever is greater. As used herein, a step of “providing” a structural element recited in a method claim means and includes obtaining, fabricating, purchasing, acquiring or otherwise gaining access to the structural element for performing the steps of the method. As used herein, the claim terms are to be given their broadest reasonable meaning unless a clear disavowal of that meaning appears in the record in substantially the following form (“As used herein the term______is defined to mean______”)

1. A restraint system for a vehicle having a frame with a seat attached thereto for holding an occupant, the restraint system comprising:
a first seat belt comprising a first length of seat belt webbing having a first intermediate latch component the first intermediate latch component dividing the first length of seat belt webbing into a first shoulder belt portion and a first lap belt portion, the first seat belt further comprising a first upper anchor attaching the first shoulder belt portion to the vehicle frame, a first lower anchor attaching the first lap belt portion to the vehicle frame, and a first intermediate latch lower component attached to the vehicle frame, the first intermediate latch lower component cooperating with the first intermediate latch upper component to form a releasable first intermediate latch, whereby attaching the first intermediate latch upper component to the first intermediate latch lower component forms the first seat belt into a first three-point restraint;
a second seat belt comprising a second length of seat belt webbing, the second seat belt further comprising a second upper anchor attaching an upper portion of the second seat belt to the vehicle frame and a second lower anchor attaching a lower portion of the second seat belt to the vehicle frame, the second upper anchor and the second lower anchor cooperating to form the second seat belt into a diagonal two-point restraint;
wherein the first and the second lower anchors and the first intermediate latch are interconnected by a common quick-release mechanism, whereby actuating the quick-release mechanism releases the first intermediate latch and the first and second lower anchors thereby allowing rapid egress from the restraint system.

2. The restraint system of claim 1, wherein:
the quick-release mechanism releases the first and second lower anchors and the first intermediate latch substantially simultaneously.

3. The restraint system of claim 1, wherein:
the quick release mechanism comprises a control link, operated by a single pull handle that is separate from the first intermediate latch and the first and second lower anchors.

4. The restraint system of claim 1, wherein:
the first lower anchor comprises a first terminal latch plate attached to the first lap belt portion and a first terminal buckle attached to the vehicle frame, and the second lower anchor comprises a second terminal latch plate attached to the second seat belt and a second terminal buckle attached to the vehicle frame.

5. The restraint system of claim 4, wherein:
the first lower anchor and the second lower anchor are located on the same lateral side of the seat, proximal the seat reference point.

6. The restraint system of claim 1, wherein:
the first intermediate latch upper component comprises a latch plate and the first intermediate latch lower component comprises a buckle.

7. The restraint system of claim 1, wherein:
the first intermediate latch upper component and the first lower anchor are configured to be incompatible, whereby the first intermediate latch upper component does not mate with the first lower anchor.

8. The restraint system of claim 1, wherein:
the first upper anchor and the second upper anchor each comprises a seat belt retractor.

9. (canceled)

10. A restraint system for a vehicle having a frame with a seat attached thereto for holding an occupant, the restraint system comprising:
a first seat belt comprising a first length of seat belt webbing having a first intermediate latch upper component, the first intermediate latch upper component dividing the first length of seat belt webbing into a first shoulder belt portion and a first lap belt portion, the first seat belt further comprising a first upper anchor attaching the first shoulder belt portion to the vehicle frame, a first lower anchor attaching the first lap belt portion to the vehicle frame, and a first intermediate latch lower component attached to the vehicle frame, the first intermediate latch lower component cooperating with the first intermediate latch upper component to form a releasable first intermediate latch, whereby attaching the first intermediate latch upper component to the first intermediate latch component lower component forms the first seat belt into a first three-point restraint;
a second seat belt comprising a second length of seat belt webbing having a second intermediate latch upper component, the second intermediate latch upper component dividing the second length of seat belt webbing into a second shoulder belt portion and a second lap belt portion, the second seat belt further comprising a second upper anchor attaching the second shoulder belt portion to the vehicle frame, a second lower anchor attaching the second lap belt portion to the vehicle frame, and a second intermediate latch lower component attached to the vehicle frame, the second intermediate latch lower component cooperating with the second intermediate latch upper component to form a releasable second intermediate latch, whereby attaching the second intermediate latch upper component to the second intermediate latch component lower component forms the second seat belt into a second three-point restraint;
the first lower anchor, the second lower anchor, the first intermediate latch, and the second intermediate latch being interconnected by a common quick-release mechanism, whereby actuating the quick-release mechanism releases first lower anchor, the second lower anchor, the first intermediate latch, and the second intermediate latch thereby allowing rapid egress from the restraint system.
